(19) United States
(12) Patent Application Publication
(10) Pub. No.: US 2002/0062837 A1
(43) Pub. Date: May 30, 2002

(54) Cleaning method for vapor phase deposition apparatus, and vapor phase deposition apparatus

(75) Inventors: Mamiko Miyanaga, Narita-shi (JP); Yoshikatsu Shirai, Narita-shi (JP); Masahiro Morimoto, Narita-shi (JP)

Correspondence Address: MOSER, PATTERSON & SHERIDAN, L.L.P., Suite 1500, 3040 Post Oak Blvd., Houston, TX, 77056, US

(73) Assignee: Applied Materials, Inc.

(21) Appl. No.: 10/045,746

(22) Filed: Oct. 26, 2001

(30) Foreign Application Priority Data
Oct. 26, 2000 (JP) P2000-327367

(51) Int. Cl. B08B 5/00

(52) U.S. Cl. 134/1; 134/19; 134/108; 34/265

(57) ABSTRACT

A cleaning method for a CVD apparatus which forms films on wafers by introducing film forming gas into a chamber by means of a shower head. In this method, the NF₃ gas, which forms the cleaning gas including a compound containing fluorine atoms, is activated by exposure to microwaves by a microwave generating source, and then introduced into the chamber. The temperature of the lid section is raised by heating the lid section by means of a heater plate, or halting supply of cooling water to the lid section from the water supply source, whereby the temperature of the shower head during cleaning is raised above the temperature at which film formation onto the wafer is performed.

### BACKGROUND OF THE INVENTION

1. Field of the Invention

The present invention relates to a cleaning method for a vapor phase deposition apparatus, and to a vapor phase deposition apparatus.

2. Related Background Art

A chemical vapor phase deposition (CVD) apparatus forms a thin film on a substrate by creating a desired chemical reaction of a film forming gas. The gas is input into the chamber via a shower head.

Since the CVD apparatus adopts a method for forming thin films by chemical reaction of film forming gas as described above, the products generated by the reaction of the film forming gas also become adhered to the interior of the chamber, in addition to the substrate. When reaction product adheres to the interior of the chamber in this way, there is a risk that it may adversely affect film deposition, and hence cleaning of the chamber is carried out after a prescribed times of deposition.

In the prior art, cleaning is generally performed by a method wherein a cleaning gas (for example, NF₃) is introduced into the chamber, and a high-frequency voltage is applied thereto to create an RF plasma, the accumulated reaction product being etched away by the excited active atoms.

### SUMMARY OF THE INVENTION

The present inventors studied the prior art described above and discovered the following problems. Namely, particles are generated inside the chamber by the aforementioned cleaning method using RF plasma.

Therefore, a milder cleaning method for improving this problem has been conceived, whereby cleaning gas is activated by microwaves, without creating a plasma inside the chamber, and the active atoms thus generated are caused to react with the reaction product adhering to the interior of the chamber. However, in a cleaning method which simply uses microwaves, in some cases, a portion of the reaction product remains unremoved from the shower head even after cleaning, and hence removal efficiency is poor and there is a risk that adverse effects on film formation will result.

Therefore, the object of the present invention is to provide a vapor phase deposition apparatus and a cleaning method for a vapor phase deposition apparatus having excellent removal efficiency of the reaction product adhering to the interior of the chamber.

The present inventors made the following findings as a result of thorough research aimed at achieving the aforementioned object. Namely, the shower head inside the chamber is cooled and maintained at a low temperature (approximately 30° C.), in order to suppress reaction of the film forming gas inside the shower head. They deduced that as this cooling operation is continued during cleaning also, the low temperature environment created by this cooling causes a reduction in the reaction product removal efficiency in the shower head. Therefore, they discovered that by performing similar cleaning whilst having raised the temperature of the shower head to a temperature greater than that used during film formation, the removal efficiency of the reaction product in the shower head is improved, and hence they arrived at the present invention.

A cleaning method for a vapor phase deposition apparatus according to the present invention is a cleaning method for a vapor phase deposition apparatus for forming film onto a substrate by introducing film forming gas into a chamber via a shower head, comprising: (1) a step of activating a cleaning gas including a compound containing fluorine atoms by exposure to microwaves, and introducing the radicals of the cleaning gas into the chamber; and (2) a step for raising the temperature of the shower head to a temperature greater than that used when forming film on the substrate.

According to this method, by raising the temperature of the shower head above that used when performing film formation onto the substrate, reaction between the radicals in the cleaning gas and the reaction product adhering to the shower head is promoted and the removal efficiency of the reaction product is improved. Moreover, since the cleaning gas is activated by microwaves without generating a plasma inside the chamber, generation of particles inside the chamber is suppressed.

In the cleaning method for a vapor phase deposition apparatus according to the present invention, the supply of the cooling medium to the chamber for cooling the shower head is restricted. The shower head may be cooled by cooling medium supplied to the chamber. Consequently, by restricting the supply of cooling medium during cleaning, the temperature of the shower head is raised.

Moreover, it is also possible for heat to be applied to the shower head by a heater. By adopting this composition, it is possible to raise the temperature of the shower head rapidly. In particular, the temperature rise in the shower head is performed efficiently if the supply of cooling medium to the chamber is restricted and heat is applied to the shower head by means of a heater.

In the cleaning method for a vapor phase deposition apparatus according to the present invention, the temperature is raised preferably to a temperature of 50° C. or above, desirably, 50° C.-150° C., and more desirably, 70° C.-10° C., and even more desirably, 75° C.-85° C. Since the temperature of the shower head is usually maintained at a temperature of approximately 20° C.-45° C. during film formation, the efficiency of removing deposited reaction product adhering to the shower head is increased by raising the temperature of the shower head to 50° C. or above during cleaning. As the temperature of the shower head falls lower than 50° C., the effect of increased efficiency in removing deposits tends to become lost.

In particular, if the film forming gas contains a gas consisting of a compound containing tungsten atoms, then the temperature of the shower head is suitably raised to 70° C. or above, and desirably, 70° C.-100° C., and more desirably, 75° C.-85° C. If the film forming gas contains a gas consisting of a compound containing tungsten atoms, then a tungsten layer having electrical conductivity is formed on top of the substrate. In recent years, with miniaturization of semiconductor integrated circuits, and the like, so-called tungsten plugs (W-plug) have come to be used for a portion of the 8888metallic wiring formed on a substrate, such as a semiconductor wafer, or the like, from the viewpoints of improving reliability of wiring and further improving evenness in wiring level. These tungsten plugs involve filling tungsten (W) into holes (through holes, Via holes, and the like) provided in the insulating layers in order to form interlayer connections. In this way, the present inventors discovered that if the temperature of the shower head is raised to the aforementioned 70° C. or above when cleaning the interior of the chamber after forming a tungsten layer, then the removal efficiency of the reaction product adhering to the shower head is substantially improved.

The vapor phase deposition apparatus according to the present invention is capable of implementing the aforementioned cleaning method for vapor phase deposition apparatus according to the present invention. The vapor phase deposition apparatus according to the present invention is an apparatus comprising: (1) a chamber comprising a shower head and a circulation passage for passing a cooling medium for cooling the shower head; (2) a feed passage connected to one end of the circulation passage and leading to the circulation passage, along which the cooling medium travels; (3) a return passage connected to the other end of the circulation passage and exiting from the circulation passage, along which the cooling medium travels; (4) a bypass passage connecting the feed passage and the return passage; and (5) a control valve for controlling the flow of the cooling medium travelling in the bypass passage. Desirably, this vapor phase deposition apparatus further comprises a heater for changing the temperature of the shower head.

Moreover, the vapor phase deposition apparatus according to the present invention also comprises: (1) a chamber having a shower head for introducing film forming gas; and (2) a heater for changing the temperature of the shower head.

Desirably, the vapor phase deposition apparatus according to the present invention further comprises cleaning gas introducing means for activating a cleaning gas by exposure to microwaves, and introducing the radicals of the cleaning gas into the chamber.

Moreover, desirably, the vapor phase deposition apparatus according to the present invention further comprises a gas supply source for supplying a gas consisting of a compound containing tungsten atoms into the chamber.

The present invention can be understood more fully from the following detailed description and the accompanying drawings. These simply serve to indicate examples and should not be considered to limit the present invention.

### BRIEF DESCRIPTION OF THE DRAWINGS

FIG. 1 is a compositional view showing one preferred embodiment of a vapor phase deposition apparatus according to the present invention;

FIG. 2 is a plan view showing one preferred embodiment of a vapor phase deposition apparatus according to the present invention;

FIG. 3 is a graph showing the manner of temperature rise of a face plate by means of a lid section, in a case where the temperature of the lid section is raised only by halting the supply of cooling water to the lid section by means of a three-way valve and bypass passage; and

FIG. 4 is a graph showing the manner of temperature rise of a face plate by means of a lid section, in a case where the temperature of the lid section is raised by halting the supply of cooling water to the lid section by means of a three-way valve and bypass passage, and by heating the lid section by means of a heater plate.

### DESCRIPTION OF THE PREFERRED EMBODIMENTS

Below, an embodiment of the present invention is described in detail with reference to the accompanying drawings. Similar constituent elements are similarly labelled and repeated description thereof is omitted.

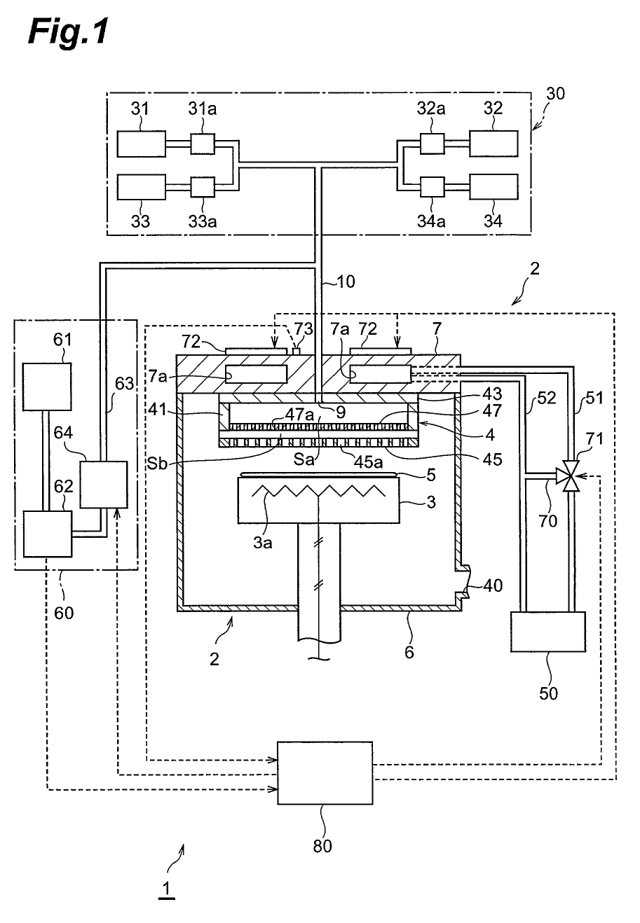

FIG. 1 is a compositional view showing one preferred embodiment of a vapor phase deposition apparatus according to the present invention. This vapor phase deposition apparatus (CVD apparatus) 1 comprises a chamber 2 in which an Si wafer (base) 5 is accommodated, and a film forming gas supply source 30 for supplying film forming gas into the chamber 2.

The chamber 2 comprises an aluminium vessel section 6 accommodating a suscepter 3 on which the wafer 5 is mounted, an aluminium lid section 7 for hermetically sealing the vessel section 6, and a shower head 4 having a hollow cylindrical shape. This shower head 4 is supported above the suscepter 3 by means of the upper face and sides thereof contacting the lid section 7. The suscepter 3 is provided in a sealed manner on the chamber 2, by means of an O ring, metal seal, or the like, and it is also provided movably in the vertical direction by means of a moving mechanism (not illustrated). Thereby, the interval between the wafer 5 and the shower head 4 can be adjusted. Moreover, a heater 3a is provided inside the suscepter 3, and the wafer 5 can be heated to a prescribed temperature by means of this heater 3a.

The shower head 4 comprises a barrel section 41 having an approximately cylindrical shape, and a base plate 43 formed with a gas supply hole 9 in the centre thereof for supplying film forming gas, as described hereinafter, is provided at the upper end portion thereof. On the other hand, at the lower end portion of the barrel section 41, there is provided a face plate 45 having a plurality of through holes 45a formed in the plate surface thereof. Moreover, a blocker plate 47 formed with a plurality of through holes 45a in the plate face thereof is provided inside the shower head 4, in such a manner that it is approximately parallel with the face plate 45. A space region Sa is created by the barrel section 41, base plate 43 and blocker plate 47, and a space region Sb is created by the barrel section 41, face plate 45 and blocker plate 47. The base plate 43 is formed in such a manner that the surface thereof facing to the blocker plate 47 is approximately smooth, in other words, it has a surface which does not substantially contain indentations.

Moreover, an opening section 40 is provided in the bottom of the vessel section 6 of the chamber 2. A vacuum pump (not illustrated) for reducing the interior of the chamber 2 to a vacuum is connected to this opening section 40 by means of a pipe (not illustrated).

Meanwhile, the film forming gas supply source 30 is provided with a WF₆ gas source 31, SiH₄ gas source 32, Ar gas source 33 and H₂ gas source 34. These respective gas sources 31-34 are connected to the gas supply hole 9 provided in the base plate 43 of the shower head 4, by means of a pipe 10 equipped with MFC (mass flow controllers) 31a-34a for controlling the mass flow of each gas. Thereby, each type of gas (WF₆ gas, SiH₄ gas, Ar gas and H₂ gas) is introduced to the shower head 4 from the film forming gas supply source 30, and after mixing and dispersing sufficiently inside the space region Sa or space region Sb, it is supplied into the chamber 2 via the blocker plate 47 and face plate 45.

In this CVD apparatus 1, since the respective gases (WF₆ gas, SiH₄ gas, Ar gas and H₂ gas) are mixed and dispersed, there is a tendency for the WF₆ gas and the SiH₄ gas to become liable to react within the shower head 4. If these two gases react together inside the shower head 4, then the concentration ratios of WF₆ gas and SiH₄ gas supplied to the chamber 2 will differ from the concentration ratios of WF₆ gas and SiH₄ gas which actually arrive at the wafer 5 mounted on the suscepter 3, and hence there is a risk that film formation onto the wafer 5 will not be accomplished satisfactorily.

Therefore, the CVD apparatus 1 is provided with a cooling system for suppressing reaction of the WF₆ gas and SiH₄ gas within the shower head 4 by cooling the shower head 4 via the lid section 7. This cooling system comprises a water supply source 50 for supplying cooling water as a cooling medium, a feed passage 51 for leading cooling water supplied by the water supply source 50 to the lid section 7, and a return passage 52 for returning the cooling water that has performed heat exchange in the lid section 7 back to the water supply source 50.

A circulation passage 7a for circulating the cooling water supplied by the water supply source 50 is provided inside the lid section 7, and the feed passage 51 and return passage 52 are connected respectively to an inlet and outlet of the circulation passage 7a. Thereby, the cooling water supplied from the water supply source 50 circulates through the circulation passage 7a inside the lid section 7 and the lid section 7 is hence cooled by heat exchange. By cooling of the lid section 7, the base plate 43, barrel section 41, blocker plate 47 and face plate 45 in contact with the lid section 7 are cooled, and hence the shower head 4 is cooled.

The feed passage 51 and return passage 52 are linked by a bypass passage 70 outside the chamber 2. A three-way valve (control valve) 71 is provided in the section where the feed passage 51 and bypass passage intersect.

Therefore, by shutting off the feed passage 51 by means of the three-way valve 71 to halt supply of cooling water to the lid section 7, and opening the bypass passage 70, the flow of cooling water is changed from a flow path circulating from the water supply source 50, to the feed passage 51, the circulation passage 7a, return passage 52 and water supply source 50, and the cooling water can be made to circulate along a path from the water supply source 50, to the feed passage 51, bypass passage 70, return passage 52 and water supply source 50. In this manner, it is possible to allow the temperature of the lid section 7 to rise.

Moreover, by shutting off the bypass passage 70 by means of the three-way valve 71 to halt the flow of cooling water through the bypass passage 70, and opening the feed passage 51, the flow of cooling water is changed from a flow path circulating from the water supply source 50, to the feed passage 51, bypass passage 70, return passage 52 and water supply source 50, and the cooling water can be made to circulate along a path from the water supply source 50, to the feed passage 51, circulation passage 7a, return passage 52 and water supply source 50. In this manner, it is possible to lower the temperature of the lid section 7.

In raising the temperature of the lid section 7, it is not necessary to halt supply of the cooling water to the lid section 7 completely, by shutting off the feed passage 51 completely by means of the three-way valve 71, and hence the temperature of the lid section 7 can be raised even if the supply of cooling water to the lid section 7 is partially restricted by partially shutting off the feed passage 51.

Moreover, the CVD apparatus 1 comprises cleaning gas introducing means 60 for cleaning the interior of the chamber 2 after a prescribed number of film formation operations. The cleaning gas introducing means 60 comprises, for example, an NF₃ gas supply source 61 for supplying NF₃ gas, being a cleaning gas comprising compounds containing fluorine atoms. This NF₃ gas supply source 61 is connected via a pipe 63 to the pipe 10.

An MFC (mass flow controller) 61a for controlling the mass flow of NF₃ gas supplied by the NF₃ gas supply source 61 is provided on the pipe 63. Furthermore, a microwave generating source 64 for activating the NF₃ gas is also provided on the pipe 63. Thereby, NF₃ gas supplied from the NF₃ gas supply source 61 is exposed to the microwaves generated by the microwave generating source 64 and activated thereby, whereupon it passes along pipe 63 and pipe 10 and is introduced into the shower head 4 from the gas supply hole 9.

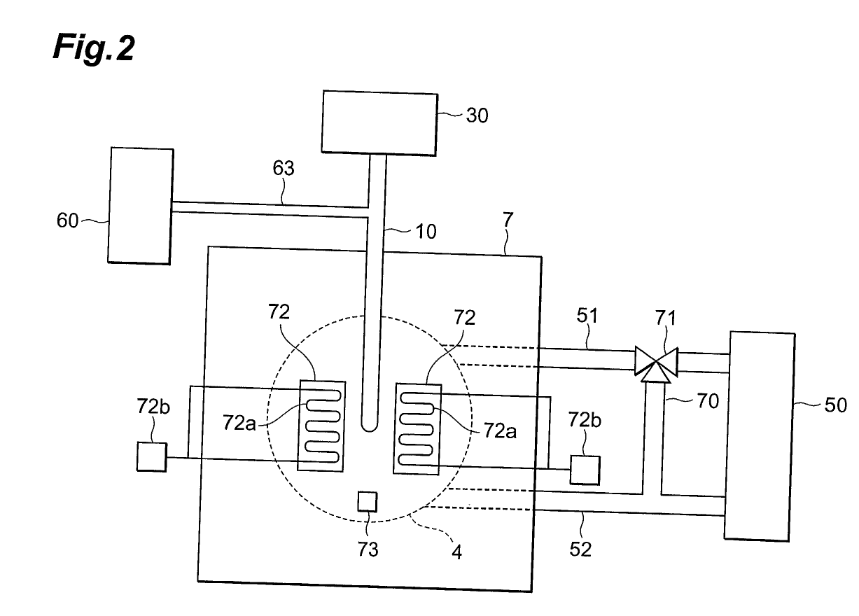

Furthermore, the CVD apparatus 1 is also provided with a heater plate (heater) 72 for raising the temperature of the lid section 7. FIG. 2 is a plan view showing the approximate composition of a CVD apparatus 1 according to the present embodiment. As shown in FIG. 2, the heater plate 72 comprises an electric heating wire 72a coiled inside silicon rubber, and the amount of heat generated thereby can be adjusted by adjusting the voltage and current supplied thereto from a power source 72b. A pair of such heater plates 72 are provided, on either side of the pipe 10, on the upper side of the lid section 7 above the shower head 4.

Furthermore, the CVD apparatus 1 is provided with a thermocouple 73 as temperature detecting means for detecting the temperature of the lid section 7, situated on the upper face of the lid section 7. Since the temperature differential between the temperature of the lid section 7 and the temperature of the shower head 4, and in particular, between the temperature of the lid section 7 and that of the face plate 45, is previously known, it is possible to know the temperature of the shower head 4, and in particular, the face plate 45, by detecting the temperature of the lid section 7 by means of the thermocouple 73.

Furthermore, as shown in FIG. 1, the CVD apparatus 1 is provided with a control apparatus 80 for controlling the opening and closing of the three-way valve 71, and the on/off operation of the heater plate 72 and the microwave generating source 64. This control apparatus 80 is connected electrically to the three-way valve 71, heater plate 72, microwave generating source 64 and MFC 62. Thereby, when an ON signal from the MFC 62 is input to the control apparatus 80, the control apparatus 80 sends an ON signal to the microwave generating source 64, and it also sends a signal for shutting off the feed passage 51 and opening the bypass passage 70 to the three-way valve 71, as well as sending an ON signal to the heater plate 72.

Moreover, the control apparatus 80 is connected electrically to the thermocouple 73, and temperature information detected by the thermocouple 73 is fed back to the control apparatus 80, which sends, to the heater plate 72, a signal for adjusting the voltage and current supplied to the electrical heating wire 72a on the basis of this temperature information, thereby adjusting the amount of heat generated by the heater plate 72.

There follows a description of one example of a cleaning method for a vapor phase deposition apparatus according to the present invention, using a CVD apparatus 1 constituted in this manner. Here, the description includes a film forming process for forming a tungsten layer onto a wafer 5.

In the film forming process, firstly, the interior of the chamber 2 is reduced to a vacuum by means of a vacuum pump. Under this vacuum pressure, a wafer 5 (here, titanium (Ti) and titanium nitride (TiN) are deposited in this order on a Si wafer which may or may not comprise holes, and recess sections, such as trenches, or the like, formed thereon) is conveyed into the chamber 2 from a load lock chamber, or other chamber, or other specified location, such as a wafer preparation space, or the like, and it is mounted and accommodated on the suscepter 3. Next, Ar gas and H₂ gas are supplied to the chamber 2 from respective supply sources 33, 34, via the tube 10, and pressure adjustment is performed such that the interior of the chamber 2 reaches a prescribed pressure.

After the pressure of the interior of the chamber 2 has stabilized to a prescribed value, WF₆ gas and SiH₄ gas as film forming gas, are supplied to the shower head 4 from respective supply sources 31, 32, via the pipe 10. In this case, cooling water is caused to circulate along a path from the water supply source 50, to feed passage 51, circulation passage 7a, return passage 52, and back to the water supply source 50, and the shower head 4 is thus cooled by cooling the lid section 7.

Desirably, cooling of the shower head 4 is performed by maintaining the temperature of the face plate 45 in the range of 20° C.-45° C. By so doing, reaction between the WF₆ gas and SiH₄ gas inside the shower head 4 can be adequately suppressed. Thereby, it is possible to prevent the concentration ratio of the two gases reaching the wafer 5 surface from changing to a problematic degree with respect to the concentration ratio of the two gases supplied by the film forming gas supply source 30. In other words, it is possible to maintain a suitable balance in the concentration ratios of the two gases. Consequently, it is possible to confirm that the compositional ratio of the tungsten silicide (WxSiy) generated in nucleus formation is a desired one that is suitable to formation of a W layer. Consequently, it is possible to achieve a prescribed desirable structure for the crystalline structure of the WxSiy layer, and hence the residual stress between the WxSiy layer and the W layer can be reduced satisfactorily. Thereby, it is possible adequately to suppress deterioration or decline in the film properties of the wiring layers formed by the WxSiy layer and W layer, and hence stress in these wiring layers, or any increase in the resistivity thereof, can be restricted.

Furthermore, since the reaction between WF₆ gas and SiH₄ gas inside the space regions Sa, Sb of the shower head 4 can be adequately suppressed, it is possible sufficiently to prevent generation of particles caused by the products of reactions between these two gases.

The two gases introduced from the gas supply hole 9 into the space region Sa are dispersed and mixed sufficiently by the blocker plate 47, and then flow to the space region Sb via the plurality of through holes 47a. The combined gas of WF₆ gas and SiH₄ gas introduced into the space region Sb passes through the through holes 45a in the face plate 45 and flows out down from the shower head 4 and is supplied to the wafer 5.

On the other hand, in addition to supplying WF₆ gas and SiH₄ gas to the chamber 2, electric power is supplied to the heater 3a of the suscepter 3, and the wafer 5 is heated via the suscepter 3 so that it assumes a prescribed temperature. Thereby, the WF₆ gas and SiH₄ gas arriving at the wafer 5 is caused to react and tungsten silicide (WxSiy) is deposited as nuclei on the wafer 5. This formation of a WxSiy film is performed for a prescribed period of time, for example, a period of several seconds to several tens of seconds, whereupon the supply of SiH₄ gas is halted and the flow rate of the WF₆ gas is adjusted. Thereby, tungsten (W) is deposited onto the WxSiy film on the wafer 5.

After continuing to form a W layer for a prescribed period of time, the film formation is halted by halting the supply of WF₆ gas and SiH₄ gas. Thereupon, the WF₆ gas and SiH₄ gas remaining in the chamber 2 is purged by using Ar gas, according to requirements, whereupon the wafer 5 having an WxSiy layer and W layer formed thereon is conveyed out to the exterior of the chamber 2.

After this film formation process has been performed a prescribed number of times, for example, after film formation has been performed for 25 wafers 5, then cleaning of the interior of the chamber 2 is carried out. In cleaning, firstly, the NF₃ gas supply source 61 is switched on, in such a manner that NF₃ gas forming a cleaning gas is supplied into the chamber 2. By so doing, the MFC 62 is operated and a prescribed quantity of NF₃ gas passes through the tube 63 and into the chamber 2, whilst an ON signal from the MFC 62 is input to the control apparatus 80.

When the ON signal of the MFC 62 is input to the control apparatus 80, the control apparatus 80 sends an ON signal to the microwave generating source 64. Thereby, microwaves are generated, the NF₃ gas passing along the tube 63 is exposed to the microwaves, and is activated thereby. The activated NF₃ gas is introduced via pipe 63 and pipe 10, into the shower head 4, from the gas supply hole 9.

Moreover, when the ON signal of the MFC 62 is input to the control apparatus 80, the control apparatus 80 sends the three-way valve 71 a signal for restricting supply of cooling water to the lid section 7. Thereby, the feed passage 51 is shut off and the supply of cooling water to the lid section 7 is halted, in addition to which the bypass passage 70 is opened. Thereby, the flow of cooling water is changed from the flow path circulating from the water supply source 50, to the feed passage 51, circulation passage 7a, return passage 52, and back to the water supply source 50, and instead the cooling water circulates along a flow path from the water supply source 50, to the feed passage 51, bypass passage 70, return passage 52, and back to the water supply source 50. In this way, the temperature of the lid section 7 is raised by halting the supply of cooling water to the lid section 7, and by this means, the temperature of the shower head 4, and in particular, the face plate 45, is raised (temperature raising step).

Furthermore, when the ON signal of the MFC 62 is input to the control apparatus 80, the control apparatus 80 sends an ON signal to the heater plate 72. Thereby, the heater plate 72 starts to heat up, the temperature of the lead section 7 is raise, and hence the temperature of the shower head 4, and in particular, the face plate 45, is raised (temperature raising step).

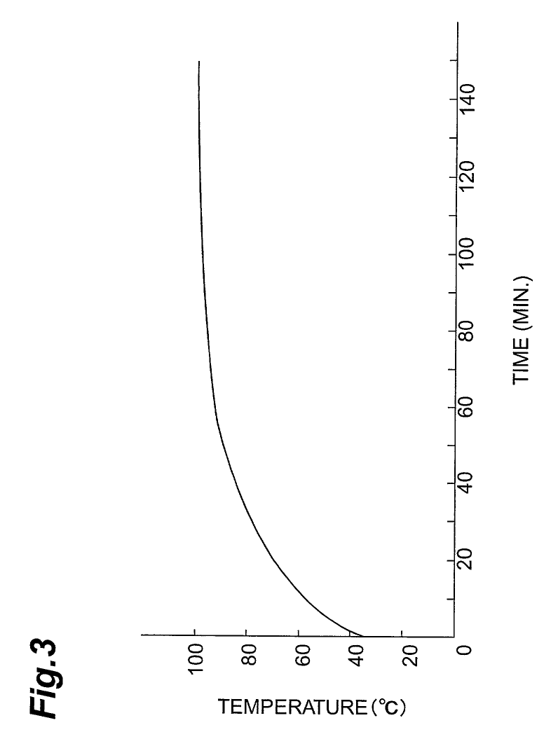

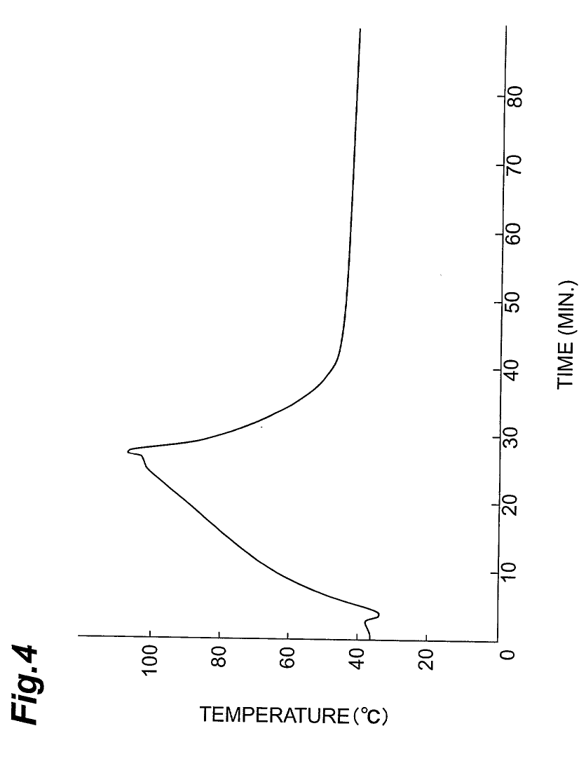

Here, FIG. 3 and FIG. 4 illustrate an experiment example to demonstrate how the efficiency of raising the temperature of the face plate 45 by means of the lid section 7 changes between a case where the temperature of the lid section 7 is raised only by halting supply of cooling water to the lid section 7 by means of the three-way valve 71 and the bypass passage 70 without performing heating by means of the heater plate 72, and a case where the temperature of the lid section 7 is raised by heating it by means of a heater plate 72, in addition to halting supply of cooling water to the lid section 7 by means of the three-way valve 71 and the bypass passage 70.

As shown in FIG. 3, when the temperature of the lid section 7 was raised only by halting the supply of cooling water to the lid section 7 by means of the three-way valve 71 and bypass passage 70, it took one hour or more for the temperature of the face plate 45 to reach a temperature of 80° C. which is suitable for cleaning. However, as shown in FIG. 4, when the temperature of the lid section 7 was raised by heating by means of a heater plate 72, as well as halting the supply of cooling water to the lid section 7 by means of the three-way valve 71 and bypass passage 70, then the time required to raise the temperature of the face plate 45 to a temperature of 80° C. suitable for cleaning was approximately 15 minutes. In this way, if the temperature of the lid section 7 is raised by combining the use of heating by a heater plate 72 with halting of the supply of cooling water to the lid section 7 by means of the three-way valve 71 and bypass passage 70, then it is possible to bring the shower head 4 to a state suitable for cleaning in a very short period of time, and hence improved efficiency in cleaning tasks can be achieved.

Temperature information for the lid section 7 is fed back to the control apparatus 80, by means of the thermocouple 73. The control apparatus 80 sends a signal for controlling voltage and current to the heater plate 72 on the basis of this temperature information. By means of this feed back control, the temperature of the lid section 7, in other words, the temperature of the face plate 45, is maintained within a prescribed range.

Here, the temperature of the shower head 4 during cleaning, and in particular, the temperature of the face plate 45, is suitably raised to a temperature of 50° C. or above, desirably, 50° C.-150° C., and more desirably, 70° C.-100° C., and even more desirably, 75° C.-85° C. Since the temperature of the shower head 45 is maintained at a suitable temperature of approximately 20° C.-45° C. during film formation, the efficiency of removing deposited reaction products adhering to the shower head 45 is increased by raising the temperature of the shower head 4 to 50° C. or above during cleaning. As the temperature of the shower head 45 falls lower than 50° C., the effect of increased efficiency in removing deposits tends to become lost. Moreover, as the temperature of the shower head 4 becomes higher than 150° C., there risk of a problem occurring in the chamber 2 tends to become higher.

In particular, in the case of the present embodiment, wherein the film forming gas includes a gas consisting of a compound containing tungsten atoms, such as WF₆ gas, then suitably, the temperature of the shower head 4 is 70° C. or above, desirably, 70° C.-100° C., and more desirably, 75° C.-85° C. In this way, the present inventors discovered that, when cleaning the interior of the chamber after forming a tungsten layer, the efficiency of removal of reaction products adhering to the shower head 4 is improved, if the temperature of the shower head 4 is raised to 70° C. or above. In other words, compared to a case where cleaning is performed using microwaves, without raising the temperature of the shower head 4, and the blue-coloured reaction product adhering to the shower head 4 is not adequately removed, it is confirmed that the cleaning method according to the present embodiment satisfactorily removes the reaction product to an extent whereby it is not immediately perceivable, and hence it raises removal efficiency.

When cleaning has been completed, the switch of the NF₃ gas supply source 61 is turned off and the supply of NF₃ gas is halted. By so doing, an off signal of the MFC 62 is input to the control apparatus 80.

When the OFF signal of the MFC 62 is input to the control apparatus 80, the control apparatus 80 sends an OFF signal to the microwave generating source 64. Thereby, the microwave generating source 64 halts operation. Moreover, when the OFF signal of the MFC 62 is input to the control apparatus 80, the control apparatus 80 sends an OFF signal to the heater plate 72. Thereby, the heater plate 72 halts heating.

Furthermore, when the OFF signal of the MFC 62 is input to the control apparatus 80, the control apparatus 80 sends a signal to the three-way valve 71 for restarting supply of cooling water to the lid section 7. Thereby, the bypass passage 70 is shut off, the supply of cooling water to the bypass passage 70 is halted, and the feed passage 51 is reopened. The flow of cooling water circulating in the flow path from the water supply source 50, to the feed passage 51, bypass passage 70, return passage 52, and back to the water supply source 50 is changed, and cooling water circulates in the flow path from the water supply source 50, to the feed passage 51, circulation passage 7a, return passage 52 and water supply source 50. In this way, the temperature of the lid section 7 is lowered by restarting the supply of cooling water to the lid section 7.

Thereupon, according to requirements, the NF₃ gas remaining inside the chamber 2 is removed, and the sequence returns again to the film forming process. The typical time required for the cleaning process described above is approximately 20 minutes, from the start of introduction of the cleaning gas.

As described above, according to the present embodiment of the cleaning method for a vapor phase deposition apparatus and the vapor phase deposition apparatus, the temperature of the shower head 4 is raised to a temperature greater than that used for film formation onto the wafer 5, and hence the reaction between the active elements of the NF₃ gas used as cleaning gas and the reaction product adhering to the interior of the chamber 2 is promoted, and the efficiency of removing the reaction product adhering to the shower head 4 can be improved. Moreover, since the efficiency of removing the reaction product adhering to the shower head 4 can be improved, the frequency of cleaning or replacing members such as the face plate 45, and the like, can be reduced, and the CVD apparatus 1 can be operated continuously and stably for a longer period of time.

Furthermore, in the present embodiment, since the temperature of the lid section 7, in other words, of the shower head 4, is raised by combining heating by means of a heater plate 72 with the halting of the supply of cooling water to the lid section 7, it is possible to bring the shower head 4 to an optimum state for cleaning, in a very short period of time, and hence the increased efficiency of the cleaning task can be achieved.

Moreover, in the present embodiment, since the NF₃ gas forming the cleaning gas is activated by exposure to microwaves, then it is possible to restrict the generation of particles, and the like, compared to cases where cleaning is performed by generating and activating a plasma inside the chamber 2, and hence film formation can be carried out in more suitable circumstances.

The present invention is not limited to the aforementioned embodiment, and may be modified in a variety of ways.

For example, the cleaning method and vapor phase deposition apparatus according to the present embodiment may also be used in a chamber other than a tungsten chamber. Moreover, as a method of restricting supply of cooling water to the lid section 7, rather than using a bypass passage and a three-way valve, it is also possible to use any other method which restricts the supply of cooling water to the lid section 7, such as shutting off the feed passage 51 and releasing the flow of cooling water by providing a branching passage from the feed passage 51, or the like. Furthermore, it is also possible to control the CVD apparatus 1 on the basis of operations performed by the operator, rather than performing automatic control of the CVD apparatus 1 by means of a control apparatus 80.

As described above, the present invention provides a cleaning method for vapor phase deposition apparatus and a vapor phase deposition apparatus having excellent removal efficiency of the reaction product adhering to the interior of the chamber.

Naturally, the present invention may be modified variously with respect to the foregoing description of the invention. Modifications of this kind cannot be recognised as deviating from the concepts and scope of the present invention, and all improvements which are self-evident to a practitioner in this field are included within the scope of the following claims.

1. A cleaning method for a vapor phase deposition apparatus for forming film onto a substrate by introducing film forming gas into a chamber via a shower head, comprising:
a step of activating a cleaning gas including a compound containing fluorine atoms by exposure to microwaves, and introducing the radicals of said cleaning gas into said chamber; and
a step for raising the temperature of said shower head to a temperature greater than that used when forming film on said substrate.

2. A cleaning method for a vapor phase deposition apparatus according to claim 1, wherein the supply of a cooling medium to said chamber for cooling said shower head is restricted.

3. A cleaning method for a vapor phase deposition apparatus according to claim 2, wherein heat is applied to said shower head by a heater.

4. A cleaning method for a vapor phase deposition apparatus according to claim 1, wherein heat is applied to said shower head by a heater.

5. A cleaning method for a vapor phase deposition apparatus according to claim 1, wherein the temperature of said shower head is raised to 50° C. or above.

6. A cleaning method for a vapor phase deposition apparatus according to claim 1, wherein said film forming gas includes gas consisting of a compound containing tungsten atoms, and the temperature of said shower head is raised to 70° C. or above.

7. A vapor phase deposition apparatus comprising:
a chamber comprising a shower head and a circulation passage for passing a cooling medium for cooling said shower head;
a feed passage connected to one end of said circulation passage and leading to said circulation passage, along which said cooling medium travels;
a return passage connected to the other end of said circulation passage and exiting from said circulation passage, along which said cooling medium travels;
a bypass passage connecting said feed passage and said return passage; and
a control valve for controlling the flow of said cooling medium travelling in said bypass passage.

8. A vapor phase deposition apparatus according to claim 7, further comprising a heater for changing the temperature of said shower head.

9. A vapor phase deposition apparatus according to claim 7, further comprising cleaning gas introducing means for activating a cleaning gas by exposure to microwaves, and introducing the radicals of said cleaning gas into said chamber.

10. A vapor phase deposition apparatus according to claim 7, further comprising a gas supply source for supplying gas consisting of a compound containing tungsten atoms into said chamber.

11. A vapor phase deposition apparatus comprising:
a chamber having a shower head for introducing film forming gas; and
a heater for changing the temperature of said shower head.

12. A vapor phase deposition apparatus according to claim 11, further comprising cleaning gas introducing means for activating a cleaning gas by exposure to microwaves, and introducing the radicals of said cleaning gas into said chamber.

13. A vapor phase deposition apparatus according to claim 11, further comprising a gas supply source for supplying a gas consisting of a compound containing tungsten atoms into said chamber.
